(19) United States
(12) Patent Application Publication
(10) Pub. No.: US 2025/0170811 A1
(43) Pub. Date: May 29, 2025

(54) RECYCLABLE LAMINATE FOR PACKAGING

(71) Applicant: RKW SE, Mannheim (DE)

(72) Inventors: Leonhard MAIER, Babensheim (DE); Adrien DEMBOWSKI, Mannheim (DE); Claudia SPICKER, Mannheim (DE); Luc HERMANS, Mannhiem (DE); Frederic WYPELIER, Mannheim (DE); Konrad NONIEWICZ, Mannheim (DE); Thomas STROH, Mannheim (DE); Claudia BENDER, Mannheim (DE); Christoph SCHWEITZER, Mannheim (DE)

(73) Assignee: RKW SE, Mannheim (DE)

(21) Appl. No.: 18/840,610

(22) PCT Filed: Feb. 17, 2023
(86) PCT No.: PCT/EP2023/054014

§ 371 Date: Aug. 22, 2024

(30) Foreign Application Priority Data
Feb. 22, 2022 (EP) 22157932.9
Jul. 4, 2022 (DE) 10 2022 116 655.4

(51) Int. Cl. B32B 27/20; B32B 27/32; B32B 37/15

(52) U.S. Cl. CPC B32B 27/205; B32B 27/32; B32B 37/153; B32B 2250/242; B32B 2307/30; B32B 2307/4023; B32B 2307/516; B32B 2307/54; B32B 2307/72; B32B 2307/724; B32B 2307/7376; B32B 2323/046; B32B 2439/00

(57) ABSTRACT

A recyclable laminate (1) for packaging with a sealing layer (2) and a first polyethylene film (11). The first polyethylene film (11) having at least two layers (6, 5, 3), wherein the first polyethylene film (11) is stretched in machine direction. At least one of the layers (6) has an inorganic filler to create cavities.

### CROSS-REFERENCE TO RELATED APPLICATIONS

This application is a 371 National Phase of PCT/EP2023/054014, filed Feb. 17, 2023, which claims priority from German Patent Application No. 10 2022 116 655.4, filed Jul. 4, 2022, and European Patent Application No. 22157932.9, filed Feb. 22, 2022, all of which are incorporated herein by reference as fully set forth.

### TECHNICAL FIELD

The invention relates to a recyclable laminate for packaging comprising a sealing layer and a first polyethylene film comprising at least two layers, wherein the first polyethylene film is stretched in the machine direction.

### BACKGROUND

Packaging is important for the protection of products and the shelf life of food. The range of different types of packaging is wide and includes paper packaging, glass packaging, metal packaging, composite packaging and plastic packaging.

The properties of low mass, resistance and durability favour plastics as packaging material for food. Polyethylene (PE) and polypropylene (PP) based packaging in particular prove to be ecologically advantageous, as they can be recycled particularly well.

Packaging is usually understood to be a multi-layered and one-piece arrangement of partly different films, which can be produced by means of extrusion. The term laminate refers to the joining of one film with another film to form a packaging unit. A print can be arranged between the films.

Heat sealing is a common method of producing seals and seams on flexible packaging. Adhesive systems are also occasionally used. There are a variety of types of heat sealing. The most common, especially for films, are thermosealing, bar sealing and impulse sealing.

Suitable film layers for heat sealing are LDPE and LLDPE. LDPE has better heat sealing properties than LLDPE. It seals at lower temperatures, seals over a wider temperature range and exhibits better hot tack, due in large part to the long chain branching. Metallocene LLDPE with higher alpha olefins was developed to address this disadvantage of LLDPE. Another approach to achieve the best blend of properties for a particular application is to blend LLDPE and LDPE.

EP 3 481 630 B1 describes a recyclable polyethylene film of at least 80% polyethylene material and at most 20% compatible polyolefin material, the polyethylene film being less than 40 μm thick and comprising a central layer of linear low density polyethylene and/or linear metallocene low density polyethylene and two outer layers of high density polyethylene connected to the central layer and surrounding the central layer, the HDPE content of the polyethylene film being at least 60% by volume, preferably at least 70% by volume, most preferably at least 80% by volume, and wherein the polyethylene film is stretched in at least one direction and the two outer layers together are at least three times as thick, preferably at least four times as thick, as the central layer. The film comprises a sealing layer which has an increased heat resistance.

WO 2020/148229 A1 discloses a film comprising at least one sealing layer, wherein at least one layer A of the sealing layer(s) comprises a polyethylene comprising units derived from ethylene and units derived from an a-olefin having from 4 to 10 carbon atoms. Such a film allows the film to be sealed at a lower temperature while still exhibiting desirable seal strength and desirable hot tack strength.

At the same time, the way plastic packaging is currently produced and disposed of can also be environmentally damaging in some circumstances. The consequences range from high CO₂ emissions to pollution of the oceans. To counteract this, the European Union wants to reduce the landfilling of plastic waste as part of its Green Deal. By 2030, 55% of plastic packaging waste is to be recycled.

The term “mechanical recycling” refers to the processing of plastic waste into secondary raw materials or products in which the chemical compounds of the plastics are not broken down. The waste is mechanically shredded and melted by an extruder. Plastic granulate is then produced again in the same process. This form of recycling is particularly suitable for waste streams of a type of relatively clean plastic.

Of course, there are recycling challenges involved. The plastic streams consist of a “mix” of materials, often with a high degree of contamination. The effort required to collect, sort, wash and recycle is costly and results in a raw material of limited quality. This makes it commercially unattractive to use the recycled raw materials from these streams in new products.

Focus is therefore also being placed on more sustainable product design, such as the construction of more mono-materials, better separation at source and further technical developments around automatic sorting and decolourisation, which will make mechanical recycling of these waste streams more attractive.

Now that many European countries have signed the European Plastics Pact, this could improve in a timely manner. According to this pact, by 2025 all packaging and single-use plastics must be designed to be reusable or recyclable.

### SUMMARY

The object of the present invention is to provide a recyclable laminate for packaging that meets the requirements of the Plastics Pact 2025 and is fully recyclable. The packaging should also be suitable for packaging food and for a heat sealing process. In addition, the packaging should be able to be designed to be very rigid and opaque. The packaging should show a low shrinkage. The packaging should be food grade and ecologically sustainable. In addition, no unpleasant smells should emanate from the packaging. Furthermore, the packaging should have a pleasant feel.

According to the invention, this object is achieved by a recyclable laminate, a method to produce a recyclable laminate and a use of the recyclable laminate according to the main claims. Preferred variants can be found in the subclaims, the description, the embodiments and the drawings.

According to the invention, at least one layer comprises an inorganic filler to create cavities.

Cavities can be gas-filled spaces inside a solid material. The space is surrounded by solid boundaries. In the case of a polymeric film, the space is delimited from the outside by polymeric material. Cavities can also be formed as vacuoles.

According to the invention an inorganic solid filler is used to form these cavities by monoaxial stretching. This provides the film with an advantageous opacity.

Opacity is opposite to transparency. It is a measure of the opacity in percent. In particular, the opacity of a completely opaque film is 100% and a completely or totally transparent film has an opacity of 0%.

In a particularly favourable variant, the polyethylene film has an opacity according to DIN 53416 of more than 80%, preferably more than 90%, in particular more than 95%. This means that the polyethylene film can be printed directly and does not require an opaque layer under the print, which must first be created or applied.

In a highly advantageous embodiment of the invention, the polyethylene film does not have titanium dioxide for producing opacity. This embodiment particularly meets the requirements of environmental and health protection.

The polyethylene film, which is practically free of titanium dioxide, thus complies on the one hand with the European chemicals regulation REACH and on the other hand with the amending regulation to the CLP regulation. Thus, the polyethylene film can be described as free of harmful substances.

In a variant of the invention, the sealing layer is coextruded with other layers of the polyethylene film.

Coextrusion allows the production of a multi-layer film without the need for a separate combining step. The molten polymers are carefully combined to create a layered melt, which is then processed into a plastic film in the conventional way. A major advantage of coextrusion over lamination is the ability to also be able to produce very thin layers of a material.

In a alternative embodiment of the invention, the sealing layer is bonded to the first polyethylene film by thermal lamination.

In a further alternative embodiment of the invention, the sealing layer is bonded to the first polyethylene film by an adhesive.

The task of the sealing layer is to form the desired packaging from the laminate. Thermal sealing uses two heated bars that apply pressure to the laminate to be sealed and simultaneously conduct heat to the interface, causing the films to melt at these points. The pressure ensures good contact between the laminate and assists the penetration of the molten viscous materials at the interface. After sufficient sealing time, the pressure of the bars is released and the films are released. Therefore, the hot tack of the film material is critical to the formation of an adequate seal. The full strength of the seal forms as the film material cools, but the initial strength must be sufficient to maintain the integrity of the seal during cooling.

The sealing bars usually have rounded edges to prevent puncturing of the material, and often one bar has a resilient surface to provide even pressure during sealing. The sealing jaws are usually serrated rather than flat, creating a patterned seal. Variants of thermal sealing heat only one bar and not the other. Another variation uses heated rollers instead of bars, sealing a bag, for example, as it passes through the rollers.

Ideally, the sealing layer has a thickness of more than 10 μm, preferably more than 15 μm, in particular more than 20 μm and/or less than 100 μm, preferably less than 80 μm, in particular less than 60 μm. Thus, depending on the use of the polyethylene film, a thin sealing layer or, for example, when enclosing liquids, a thick sealing layer can be realised.

In one embodiment of the invention the sealing layer is an LDPE or an LLDPE. Low density polyethylene (LDPE) is a thermoplastic material made from the monomer ethylene. LDPE has more branching (at about 2% of the carbon atoms) than HDPE, so its intermolecular forces are weaker, its tensile strength is lower and its elasticity is higher. The side branches mean that the molecules are less densely packed and less crystalline, which is why the density is lower.

According to the invention, at least one layer comprises an inorganic filler to create cavities. In a particularly favourable variant of the invention, this filled layer is formed as an inner layer. In this case, the inner layer is preferably surrounded by two unfilled layers. In one variant, this results in a three-layer film.

In a particularly advantageous variant of the invention, the filled layer is surrounded by at least two unfilled layers on both sides.

If the filled layer is surrounded by exactly two unfilled layers on both sides this results in a five-layer structure for the first polyethylene film.

In another variant of the invention, the filled layer is surrounded by 4 unfilled layers on both sides, resulting in a nine-layer structure for the first polyethylene film.

Surrounding the filled layer with unfilled layers ensures the closure of the cavities to the outside. This safely ensures that no cavity has a direct and/or indirect connection to the outside.

Hard fillers are particularly suitable for the polyethylene film according to the invention. The proportion of fillers is preferably adjusted in such a way that only microporous cavities are formed in a way, that they do not have a network of interconnections between them.

The filler content can be determined by known measuring methods such as ashing. A sample with a known weight is heated up to a temperature at which the polymer thermally decomposes but the filler does not. For example, 560° C. has proven to be a good temperature for this. The sample weight is then measured again. The polymer content per square metre can be calculated from the difference between the initial and final weights.

As an alternative to ashing, a TGA measurement is possible, in which the weight of a sample is measured continuously during heating. This test method can also clearly differentiate between polymer and filler and allows the polymer content of the film to be determined.

In one embodiment of the invention, calcium carbonate (CaCO₃) is used as the filler, preferably with an average particle size of 0.8 μm to 6.5 μm. During the stretching process, the elastic polymeric portions of the filled layer are stretched and voids are formed in the layer. In one variant of the invention, the proportion of calcium carbonate is more than 40% by weight, preferably more than 50% by weight, in particular more than 60% by weight and/or less than 90% by weight, preferably less than 80% by weight, in particular less than 70% by weight.

In addition or as an alternative to calcium carbonate (CaCO₃), a metal oxide component can be used as a filler. Alkaline earth oxides are particularly advantageous as metal oxide components, both as a filler to ensure the formation of pores in the layer and at the same time as an adhesive to ensure the adhesion of the printed image. Calcium oxide (CaO) has proven to be particularly advantageous, although the use of magnesium oxide is also conceivable.

In a particularly advantageous variant of the invention, the laminate comprises a further polyethylene film, wherein a print is located between the further polyethylene film and the first polyethylene film.

In an alternative variant, an imprint is located on the outside of the first polyethylene film and the imprint is covered with a coating layer. The coating layer can preferably be a protective lacquer to protect the print from abrasion. The protective lacquer may be glossy or matt, depending on the use.

Preferably, the print is arranged directly on an outer layer of the polyethylene film. The print or imprint can be arranged on the side facing away from the packaged product or in the sense of a counter-print between the polyethylene film and possibly another polyethylene film. In addition, the print can be executed as a print motif. In the field of films, the term print motif refers to the thematic design part of an imprint. If necessary, print motifs identifying the manufacturer may also be included in the scope of the print.

Preferably, the print is applied to an outer layer of the polyethylene film using a flexographic printing process, whereby all common printing processes are in principle suitable for this and are expressly included in the invention.

In order to realise the recyclability and thus also the sorting in modern waste separation plants, such as for example the floating-sink process, the density of the polyethylene film is less than 0.99 g/cm³, preferably less than 0.95 g/cm³, in particular less than 0.91 g/cm³ and/or more than 0.60 g/cm³, preferably more than 0.70 g/cm³, in particular more than 0.80 g/cm³. This is achieved in particular by the monoaxial stretching of the film and the formation of cavities in the filled layer.

Advantageously, the density of the laminate is less than 0.99 g/cm³, preferably less than 0.95 g/cm³, in particular less than 0.91 g/cm³ and/or more than 0.60 g/cm³, preferably more than 0.70 g/cm³, in particular more than 0.80 g/cm³.

The measurement of the thickness of the first polyethylene film was determined according to DIN 53370 and given as an average value. After stretching in the monoaxial direction, the first polyethylene film has a thickness of less than 60 μm, preferably less than 50 μm, in particular less than 40 μm, and/or more than 10 μm, preferably more than 20 μm, in particular more than 30 μm. Thus, the first polyethylene film according to the invention differs significantly from already known filled polyolefin films (FPO), the thickness of which is usually more than 100 μm.

Advantageously, the laminate has a thickness of less than 120 μm, preferably less than 100 μm, more preferably less than 80 μm and/or more than 40 μm, preferably more than 50 μm, more preferably more than 60 μm.

In an advantageous variant of the invention, the polyethylene film has a gas permeability of less than 500 cm³/m²·d·bar, preferably of less than 300 cm³/m²·d·bar, in particular of less than 100 cm³/m²·d·bar according to DIN EN ISO 2556. DIN EN ISO 2556:2000 is the German version for determining the gas permeability of films and thin sheets under atmospheric pressure using the pressure gauge method (ISO 2556:1974).

The tensile properties are determined according to DIN EN ISO 527. In the tensile test, a test strip of a film is stretched at a constant speed specified in the test standard and the force F is recorded with the change in length ΔL of the measuring section L₀.

In film packaging applications, the linear-elastic and linear-viscoelastic load ranges usually play a role. It is precisely in these light deformation ranges, for example at 2% of the secant modulus, that films are frequently loaded. In an advantageous variant of the invention, the film has a tensile stiffness at 2% secant modulus according to DIN EN ISO 527-3 of more than 500 MPa, preferably of more than 550 MPa, in particular of more than 600 MPa. The bending stiffness can be determined by the two-point, three-point and four-point methods.

Ideally, the film has a tensile strength in the machine direction according to DIN EN ISO 527-3 of more than 90 MPa, preferably more than 100 MPa, in particular more than 110 MPa.

Shrinkage or the shrinkage of plastics is understood to be a change in the dimensional stability of test specimens at temperatures T>TG (amorphous) or T>TS (semi-crystalline), which is caused by the resetting of molecular orientations and the relaxation of residual stresses. The orientations arise as a result of the processing (extrusion, injection moulding or deep drawing) and are therefore dependent on processing parameters. These parameters are the temperature of the mould and the melt, the injection and holding pressure, the flow path length and the cooling gradient of the film.

In a favourable variant of the invention, the first polyethylene film has a shrinkage according to DIN 55543-4 of less than 4%, preferably of less than 3%, in particular of less than 2%.

The Dart Drop Test, also called Falling Dart Impact Test, Drop Hammer Method or Free-Falling Dart Method according to DIN EN ISO 7765-1, is a traditional method to evaluate the impact strength or toughness of a plastic film. A drop hammer with variable weight and a diameter of 28 mm is dropped from a height of 0.66 m onto a wrinkle-free and firmly clamped film with a film thickness of 0.04 mm, at standard climate. The weight of the drop hammer at which the film is penetrated in 50% of the drop tests is determined.

For example, the film has a dart drop according to DIN EN ISO 7765-1 of more than 95 g, preferably more than 115 g, in particular more than 135 g.

Optionally, the dynamic penetration energy according to DIN EN ISO 7765-2 is more than 10 J/mm, preferably more than 12 J/mm, in particular more than 14 J/mm.

The special properties of the first polyethylene film and the laminate are achieved by the use and selection of special polymers.

Ideally, the outer, unfilled layer of the first polyethylene film comprises a blend of two polyethylenes of different densities, the higher density polyethylene having a density of more than 0.94 g/cm³ and the lower density polyethylene having a density of less than 0.94 g/cm³.

Advantageously, the proportion of the higher density polyethylene in the blend is more than 10% by weight, preferably more than 20% by weight, in particular more than 25% by weight and/or less than 50% by weight, preferably less than 40% by weight, in particular less than 35% by weight. The higher density polyethylene content gives the film excellent stiffness and heat resistance.

In a particularly favourable variant of the invention, the proportion of the low-density polyethylene in the blend is more than 50% by weight, preferably more than 60% by weight, more particularly more than 65% by weight and/or less than 90% by weight, preferably less than 80% by weight, more particularly less than 75% by weight. The proportion of low-density polyethylene ensures favourable toughness of the film.

Ideally, the higher density polyethylene is formed from an HDPE having a density greater than 0.942 g/cm³, preferably greater than 0.944 g/cm³ and/or less than 0.96 g/cm³, preferably less than 0.95 g/cm³.

Preferably, the low density polyethylene is formed from an MDPE having a density greater than 0.91 g/cm³, preferably greater than 0.92 g/cm³ and/or less than 0.95 g/cm³, preferably less than 0.94 g/cm³.

In variants of the inventions having more than three layers, one or more intermediate layers are arranged between the filled layer and the unfilled outermost layer. These intermediate layers are preferably unfilled and comprise an MDPE whose density is more than 0.91 g/cm³, preferably more than 0.92 g/cm³ and/or is less than 0.95 g/cm³, preferably less than 0.94 g/cm³.

The flow behaviour of polyolefins is described with the help of the melt index MI (Melt Index) according to ASTM 1238, usually at a temperature of 190°° C. for polyethylene and 230° C. for polypropylene at a load of 2.16 kg, 5 kg or 21.6 kg. A higher melt index here correlates with a lower average molecular weight of the polymer. At the same time, the higher the melt index of a polymer, the lower the melt viscosity, which is advantageous for a high output of the extrusion line. On the other hand, polymers with a high molecular weight, i.e. a low melt index, are advantageous in terms of mechanical stability, especially tensile strength or toughness.

Ideally, the HDPE has a melt index MI of more than 1.0 g/10 min, preferably of more than 1.25 g/10 min, more particularly of more than 1.5 g/10 min and/or less than 3.0 g/10 min, preferably of less than 2.0 g/10 min, more particularly of less than 1.75 g/10 min at 190° C. and 5 kg. Furthermore, the melt index is greater than 11 g/10 min, preferably greater than 13 g/10 min, more preferably greater than 15 g/10 min and/or less than 30 g/10 min, preferably less than 20 g/10 min, more preferably less than 17 g/10 min at 190° C. and 21.6 kg.

Preferably, the HDPE has a medium molar mass and a particularly narrow molar mass distribution, resulting in good bubble stability and processability. Furthermore, the layers with HDPE have excellent tensile strength and good elongation at break with low tendency to fibrillation.

Advantageously, the MDPE has a melt index MI of more than 1.0 g/10 min, preferably of more than 1.5 g/10 min, in particular of more than 1.9 g/10 min and/or less than 4.0 g/10 min, preferably of less than 3.0 g/10 min, in particular of less than 2.1 g/10 min at 190° C. and 5 kg. Furthermore, the melt index is more than 20 g/10 min, preferably more than 30 g/10 min, more preferably more than 40 g/10 min and/or less than 65 g/10 min, preferably less than 55 g/10 min, more preferably less than 45 g/10 min at 190° C. and 21.6 kg. Thus, the layers with MDPE as well as the film achieve a high toughness and at the same time high stiffness values.

In principle, five-layer and seven-layer films are also included within the scope of the invention, whereby the mechanical properties can be realised in an improved manner with an increasing number of layers.

The special selection of polymers as well as the design in a three-to nine-layer variant realise a particularly thin polyethylene film, which nevertheless has convincing mechanical properties, even in the design of a mono-material construction. Despite the thin design, the stiffness with simultaneous toughness, which is realised in particular by the polyethylene mixture in at least one outer layer, leads to excellent printability. In particular, the filled layer with cavities leads to an opaque film which can be ideally printed.

According to the invention, the process for producing a laminate comprises several steps. First, a mixture or several mixtures of the polymeric components are made, which is then extruded to form a polyethylene film with at least two layers. In this process, the polymer blends differ with respect to the filled and unfilled layers of the polyethylene film, wherein the polymer blend of the filled layer comprises an inorganic filler to create voids. Advantageously, the film is stretched monoaxially in the machine direction, whereby the favourable properties of the polyethylene film are achieved. This is, among other things, an advantageous opacity, so that the film can be directly provided with a print.

The film is produced by monoaxial stretching with a machine direction orientation (MDO) by heating the polyethylene film to a temperature slightly below its melting point and stretching it in a specific orientation. The stretching can also be done directly after extrusion, where the film is still at a temperature slightly below its melting point.

The MDO stretched and oriented film enables packaging of food and or articles based on a particularly thin film as well as on a uniform, single material structure. The MDO stretching achieves properties of the polyethylene film that were previously only known from multi-material constructions or from PP as well as PET films.

In an advantageous variant of the invention, the film is stretched by more than a factor of three, preferably more than a factor of four, in particular more than a factor of five. This gives the film an advantageous stiffness and a favourable opacity.

In a particularly advantageous variant, the opaque, printed film is joined to a further film to form a package, in particular a packaging laminate. In principle, all common and known joining methods are suitable for this purpose.

The further polyethylene film is preferably also based on a mono-material construction of polyethylene.

In a particularly advantageous variant of the invention, the further film is a nine-layer film, preferably based on MDPE, which is also monoaxially stretched in the machine direction.

In a favourable embodiment of the further polyethylene film, at least one outer layer has a higher density than the at least one inner layer. In this case, the outer layer comprises a mixture of at least two polyethylenes of different density, wherein the higher density polyethylene has a density of more than 0.94 g/cm³ and the lower density polyethylene has a density of less than 0.94 g/cm³.

Ideally, the density of the higher density polyethylene is greater than the lower density polyethylene by a factor, the value of the factor being greater than 1.002, preferably greater than 1.005, more preferably greater than 1.008 and/or less than 1.20, preferably less than 1.15, more preferably less than 1.10.

Preferably, the inner layer is formed of an MDPE whose density is more than 0.91 g/cm³, preferably more than 0.92 g/cm³ and/or is less than 0.95 g/cm³, preferably less than 0.94 g/cm³ and/or whose melt flow rate (at 190° C. at 2.16 kg) according to ASTM D 1238 is more than 0.1 g/10 min, preferably more than 1.0 g/10 min and/or is less than 5.0 g/10 min, preferably less than 3.0 g/10 min.

In a particularly preferred embodiment, the further polyethylene film comprises more than one inner layer, preferably more than two inner layers, more preferably more than four inner layers, all formed from the same MDPE. This particular multi-layer construction realises a particularly high toughness and stiffness of the polyethylene film, while at the same time the formation of fibrils is particularly advantageously prevented.

Ideally, the higher density polyethylene of the further film in the outer layer is formed of an HDPE whose density is more than 0.942 g/cm³, preferably more than 0.944 g/cm³ and/or less than 0.96 g/cm³, preferably less than 0,95 g/cm³ and/or whose melt flow rate (at 190° C. at 2.16 kg) according to ASTM D 1238 is more than 5 g/10 min, preferably more than 10 g/10 min and/or is less than 25 g/10 min, preferably less than 20 g/10 min.

Advantageously, the low density polyethylene of the outer layer of the further film is formed of an MDPE whose density is more than 0.91 g/cm³, preferably more than 0.92 g/cm³ and/or is less than 0.95 g/cm³, preferably less than 0, 94 g/cm³ and/or whose melt flow rate (at 190° C. at 2.16 kg) according to ASTM D 1238 is more than 0.1 g/10 min, preferably more than 1.0 g/10 min and/or is less than 5.0 g/10 min, preferably less than 3.0 g/10 min.

In a particularly simple embodiment of the further polyethylene film, the film comprises three layers. In this case, the inner layer is preferably made of an MDPE, while the two outer layers are formed of a polymer blend of HDPE and MDPE.

In a particularly advantageous variant of the invention, the further polyethylene film comprises a nine-layer structure. Preferably, three equally thin inner layers of MDPE form the core of the further film, each of which is surrounded by an inner intermediate layer. The inner intermediate layers are ideally also made of MDPE and are approximately twice as thick as the inner layers. An outer intermediate layer is arranged between each of the inner intermediate layer and the outer layer. The outer intermediate layer is formed slightly thicker than the inner intermediate layer and preferably consists of a mixture of higher and lower density polyethylene. The outer layer has a thickness which is again somewhat thicker than the thickness of the outer intermediate layer and likewise consists of a mixture of higher and lower density polyethylene, the outer layer additionally having a small proportion of additives.

In a particularly favourable variant of the further polyethylene film, the thickness of the layers is increasingly formed from the inner layer to the outer layer. This applies to the three-layer to the nine-layer further film. This version of the further film achieves particularly advantageous mechanical properties and thus realises a film that can be printed with high quality.

In addition, the further polyethylene film is ideally monoaxially stretched in the machine direction by more than a factor of 2.0, preferably by more than a factor of 3.0, in particular by more than a factor of 4.0 and/or is stretched by less than a factor of 7.0, preferably by less than a factor of 6.5, in particular by less than a factor of 6.0.

Advantageously, the further polyethylene film has a thickness of less than 60 μm, preferably less than 50 μm, in particular less than 40 μm, and/or more than 5 μm, preferably more than 10 μm, in particular more than 15 μm.

Ideally, the further polyethylene film comprises an outer layer preferably formed from a polypropylene.

Preferably, the further polyethylene film comprises an outer layer preferably formed from a HDPE.

The outer layer increases the stiffness and heat resistance of the further polyethylene film and thus also of the laminate. The improved heat resistance results in improved heat sealing performance.

According to the invention, a laminate is used as recyclable packaging. In doing so, the laminate exhibits the advantages of a mono-material construction, while achieving and exceeding many characteristics of multi-component constructions and fulfilling the requirements of the Plastic Pact of the European Union.

### BRIEF DESCRIPTION OF THE DRAWINGS

Further advantages and features of the invention can be seen from the description of an embodiment example based on drawings and from the drawings themselves.

Shown are

FIG. 1 a laminate with tthe sealing layer combined by an adhesive.

FIG. 2 a laminate with a coextruded sealing layer

### DETAILED DESCRIPTION

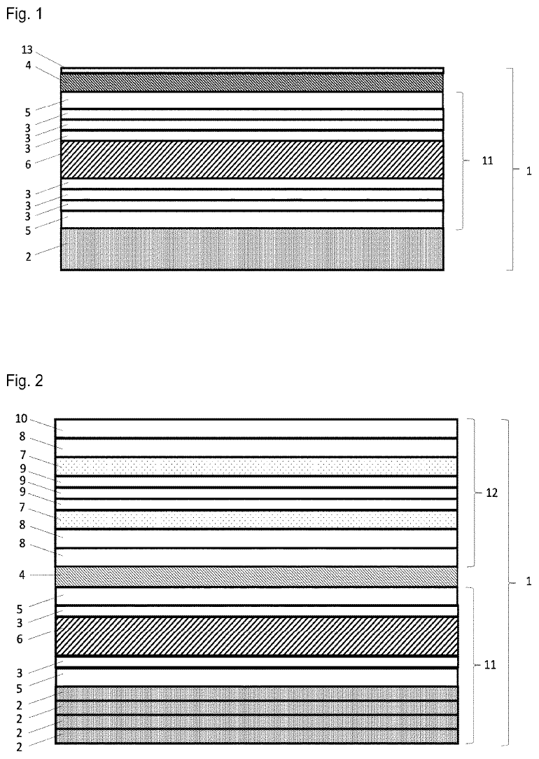

FIG. 1 shows a laminate 11 with a first polyethylene film 11, a sealing layer 2, a print 4 and a coating layer 13. In this embodiment the polyethylene film 11 has a nine-layer structure.

The layer 6 is a filled layer, whereby the proportion of CaCO₃ is approx. 55 wt. %. Furthermore, layer 6 has a proportion of LDPE of approx. 15 wt. %, a proportion of MDPE of approx. 18 wt. % and a proportion of HDPE of approx. 12 wt. %.

The layers 5 form the outer layers of the first polyethylene film 11, the layers 5 having no fillers. In the layer 5, the proportion of MDPE is about 70 wt % and the proportion of HDPE is 30 wt %. The HDPE is made, for example, from a Hostalen ACP 7740 F3, whose density is 0.946 g/cm³ and whose melt flow rate (at 190° C. at 5 kg) is 1.6 g/10 min according to ISO 1133.

Three further thin layers 3 are arranged between the filled layer 6 and the unfilled layers 5. The layer 3 is formed entirely of an MDPE, for example a Borealis Borshape FX1002, whose density is 0.937 g/cm³ and whose melt flow rate (at 190° C. at 5 kg) is 2 g/10 min according to ISO 1133.

The first polyethylene film 11 in the embodiment shown has a thickness of 119 μm after blow extrusion. After monoaxial stretching by a factor of 4.82, the thickness of the film 11 is 24.7 μm, with a density of 0.92 g/cm³.

The first polyethylene film 11 has a tensile strength in the machine direction according to DIN EN ISO 527-3 of more than 119,3 MPa. Furthermore, the shrinkage of the polyethylene film 11 according to DIN 55543-4 is less than 2,3%, while the opacity according to DIN EN ISO 2813 is more than 94%. Film 1 has a dart drop of 135.4 g according to DIN EN ISO 7765-1.

The sealing layer 2 is formed from an LDPE, has a thickness of 12 μm and is bonded to the first polyethylene film 11 with an adhesive.

FIG. 2 shows a laminate with a first polyethylene film 11 and a further polyethylene film 12. A print 4 is embedded between the two polyethylene films 11 and 12.

In this embodiment of the invention the first polyethylene film 11 comprises coextruded sealing layers 2.

The filled layer 6 is enclosed as an inner layer by one intermediate layer 3 each, whereby one unfilled layer 5 encloses each of the intermediate layers 3.

Four sealing layers 2 are arranged on the product side of the packaging.

A print 4 is arranged between the further polyethylene film 12 and the polyethylene film 11, which is printed on the opaque polyethylene film 11 before bonding. The print 4 serves to identify the food product to be packaged as well as to visually recognise and support a brand image of the food product brand.

In this embodiment, the further polyethylene film 12 is formed with nine layers in an almost symmetrical structure. The five innermost layers 7 and 9 consist entirely of an MDPE, for example a Borealis Borshape FX1002, whereby the three innermost layers 9 are significantly thinner than the two surrounding layers 7.

In each case, the outer layers 8 of the further polyethylene film 12 have a proportion of HDPE in addition to the MDPE. In the embodiment shown, the proportion of HDPE is 85% by weight and is formed, for example, from a Hostalen ACP 7740 F3.

The further polyethylene film 12 has an additional, outer layer 10 formed from a polypropylene having a melt flow index of 1 g/10 min at 230° C. and 2.16 kg. The additional, outer layer 10 exhibits high heat resistance and facilitates heat sealing of the laminate 1.

The nine-layer additional polyethylene film 12 has a thickness of 139 μm after blow extrusion. After monoaxial stretching by a factor of 5.95, the thickness of the further film 3 is 25 μm, with a density of 0.945 g/cm³.

After blow extrusion, the polyethylene film 11 has a thickness of 140 μm. After monoaxial stretching by a factor of 4.82, the thickness of film 11 is 29 μm, with a density of 0.87 g/cm³.

1. A recyclable laminate (1) for packaging comprising:
a sealing layer (2),
a first polyethylene film (11), which includes at least two layers (6, 5, 3), the first polyethylene film (11) being stretched in machine direction, and
at least one of the layers (6) comprises an inorganic filler to create cavities.

2. The recyclable laminate according to claim 1, wherein the sealing layer (2) is coextruded with the at least two layers (6, 5, 3) of the first polyethylene film (11).

3. The recyclable laminate according to claim 1, wherein the sealing layer (2) is combined with the first polyethylene film (11) by at least one of an adhesive or a thermal lamination.

4. The recyclable laminate according to claim 1, wherein the sealing layer (2) has a thickness of more than 10 μm and less than 100 μm.

5. The recyclable laminate according to claim 1, wherein the sealing layer (2) is an LDPE or an LLDPE.

6. The recyclable laminate according to claim 1, wherein two of the layers (3, 5) of the first polyethylene film (11), which are free of inorganic fillers, are directly adjoining the layer (6) comprising the aninorganic filler with one on each side of the layer (6) comprising the inorganic filler.

7. The recyclable laminate according to claim 1, further comprising a further polyethylene film (12), with a print (4) being located between the further polyethylene film (12) and the first polyethylene film (11).

8. The recyclable laminate according to claim 7, wherein the print (4) is located on an outside of the first polyethylene film (11) and the print (4) is covered with a coating layer (13).

9. The recyclable laminate according to claim 7, wherein the further polyethylene film (12) comprises an outer layer (10).

10. The recyclable laminate according to claim 7, wherein the further polyethylene film (12) comprises an outer layer (10), which has a melt flow rate (at 190°C. at 2.16 kg) according to DIN ISO 1133 which is more than 0.5 g/10 min and which is less than 1.1 g/10 min.

11. The recyclable laminate according to claim 1, wherein a density of the first polyethylene film (11) is less than 0.99 g/cm³, p and more than 0.60 g/cm³.

12. The recyclable laminate according to claim 1, wherein a density of the laminate (1) is less than 0.99 g/cm³, and more than 0.60 g/cm³.

13. The recyclable laminate according to claim 1, wherein the inorganic filler is CaCO₃ with a particle size of less than 6.5 μm.

14. The recyclable laminate according to claim 1, wherein a proportion of filler in the layer (6) comprising the inorganic filler is more than 5% by weight, and less than 60% by weight.

15. The recyclable laminate according to claim 1, wherein the first polyethylene film (11) has a thickness of less than 60 μm, and more than 10 μm.

16. The recyclable laminate according to claim 1, wherein the laminate (1) has a thickness of less than 120 μm and more than 40 μm.

17. The recyclable laminate according to claim 1, wherein the first polyethylene film (11) has a gas permeability of less than 500 cm³/m² according to DIN EN ISO 2556.

18. The recyclable packaging according to claim 1, wherein the first polyethylene film (11) has an opacity according to DIN 53416 of more than 80%.

19. The recyclable packaging according to claim 1, wherein the first polyethylene film (11) has a tensile strength in the machine direction according to DIN EN ISO 527-3 of more than 90 MPa.

20. The recyclable packaging according to claim 1, wherein the first polyethylene film (11) has a shrinkage according to DIN 55543-4 of less than 4%.

21. The recyclable packaging according to claim 1, wherein the film (1) has a tensile stiffness at 2% secant modulus according to DIN EN ISO 527-3 of more than 500 MPa.

22. The recyclable packaging according to claim 1 any one of wherein the film (1) has a dart-drop according to DIN EN ISO 7765-1 of more than 95 g.

23. A method to produce a recyclable laminate (1) for packaging with a sealing layer (2) and a first polyethylene film (11), which comprises at least two layers (6, 5, 3), and at least one of the layers (6) comprises an inorganic filler to create cavities, the method comprising withthe following steps:
creating of a mixture
extruding extrusion of the mixture into the afirst polyethylene film (11) with the at least two layers (6, 5, 3), and
stretching the first polyethylene film (11) monoaxially in thea machine direction.

24. The method according to claim 23, wherein the extrusion is carried out as a blow extrusion.

25. The method according to claim 23, wherein the first polyethylene film (11) is stretched by more than a factor of 3.

26. The method according to claim 23, further comprising coextruding the sealing layer (2) with the at least two layers (6, 5, 3) of the polyethylene film (11).

27. The method according to claim 23, further comprising combining the sealing layer (2) is-combined with the first polyethylene film (11) by an adhesive.

28. The method according to claim 23, further comprising combining the sealing layer (2) with the first polyethylene film (11) by a thermal lamination.

29. The method of claim 23, further comprising forming recyclable packaging from the recyclable laminate (1).
